(19) United States
(12) Patent Application Publication
(10) Pub. No.: US 2012/0176413 A1
(43) Pub. Date: Jul. 12, 2012

(54) METHODS AND APPARATUSES FOR MOBILE DEVICE DISPLAY MODE SELECTION BASED ON MOTION DIRECTION

(75) Inventors: Victor Kulik, San Jose, CA (US); Joseph Czompo, Santa Clara, CA (US)

(73) Assignee: QUALCOMM Incorporated, San Diego, CA (US)

(21) Appl. No.: 13/079,523

(22) Filed: Apr. 4, 2011

Related U.S. Application Data
(60) Provisional application No. 61/431,734, filed on Jan. 11, 2011.

(51) Int. Cl. G09G 5/00

(52) U.S. Cl. 345/659

(57) ABSTRACT

Methods and apparatuses are provided that may be implemented in a mobile device to allow for display mode selection based, at least in part, on a motion direction with respect to an orientation of a display of the mobile device.

### CROSS REFERENCE TO RELATED APPLICATIONS

This application claims the benefit of Provisional Application No. 61/431,734, filed Jan. 11, 2011 which is assigned to the assignee hereof and hereby expressly incorporated by reference herein.

### BACKGROUND

1. Field

The subject matter disclosed herein relates to electronic devices, and more particularly to methods and apparatuses for use in a mobile device.

2. Information

Mobile devices may be positioned in a variety of different orientations by a user. As such it may be useful to select a display mode that is compatible with a given orientation. Thus, a user may provide input directly to manually select a display mode. For example, a user may manually select a landscape or portrait mode for a presentation of content on a display.

In certain mobile devices, a current orientation of the mobile device may be identified using one or more sensors onboard the mobile device and a display mode automatically selected based on the orientation.

While such techniques work well most of the time, there may be situations/orientations wherein the mobile device is unable to make the correct selection. As such, a user may need to move the mobile device in some manner to get a more compatible (useful) display mode and/or return to a previous display mode with was compatible. This can reduce the effectiveness of the mobile device and/or negatively affect a user's experience. Indeed, in certain situations a user may need to stop what they are attempting to do and manually set a display mode and/or turn off automatic display mode selection.

### SUMMARY

Methods and apparatuses are provided that may be implemented in a mobile device to allow for display mode selection based, at least in part, on a motion direction of the mobile device.

Thus, for example, in certain implementations a mobile device may determine that an orientation of a display of the mobile device is in a particular horizontal position, and in response identify a motion direction of the mobile device with respect to the orientation of the display. The mobile device may select a display mode from a plurality of predefined display modes for use by a presentation using the display based, at least in part, on the motion direction.

In certain example implementations, a mobile device may, for example, determine that an orientation of the display is in a particular horizontal position based, at least in part, on a threshold angular range. By way of example, in certain other example implementations a mobile device may further determine that the orientation is within a threshold angular range of a representative plane that is substantially perpendicular to a force vector representative of Earth's gravitational attraction.

In certain example implementations, a motion direction may represent movement during a period of time of the mobile device along one or more angles within the same or a different threshold angular range. In certain example implementations, a mobile device may also select a display mode based, at least in part, on an identified motion mode.

In certain other example implementations a mobile device may decide to maintain a current display mode in response to a determination that the orientation of the mobile device and/or a current display mode are compatible with a motion direction and/or an identified motion mode. In certain other example implementations a mobile device may further select a different display mode in response to a determination that the orientation of the mobile device and/or a current display mode are incompatible with a motion direction and/or an identified motion mode. In certain other example implementations a method may further comprise identifying that motion-based display mode selection is permitted, prior to selecting the display mode, and/or identifying that a motion direction satisfies a threshold level prior to selecting a display mode.

In certain other example implementations, an orientation of the display of the mobile device and the motion direction may be associated with a common reference point. In certain other example implementations, certain display modes may be associated with different presentation formats, e.g., different aspect ratios, a portrait format, a landscape format, etc.

In certain other example implementations a method may further comprise rendering a presentation on a display of the mobile device using a selected display mode.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an exemplary environment that includes a mobile device enabled to select a display mode based, at least in part, on a motion direction of the mobile device, in accordance with an implementation.

FIG. 2 is an illustrative diagram showing a mobile device enabled to select a display mode, in accordance with an implementation.

FIG. 3A-B are illustrative diagrams showing a mobile device enabled to select a display mode, in accordance with an implementation.

FIG. 4A-B are illustrative diagrams showing a mobile device enabled to select a display mode, in accordance with an implementation.

FIG. 5 is a schematic block diagram illustrating certain features of a mobile device enabled to select a display mode based, at least in part, on a motion direction of the mobile device, in accordance with an implementation.

FIG. 6 is a functional flow diagram illustrating certain features of an exemplary process to select a display mode based, at least in part, on a motion direction of the mobile device, in accordance with an implementation.

### DETAILED DESCRIPTION

According to certain example implementations, a mobile device may be enabled to select a display mode based, at least in part, on a motion direction of the mobile device.

In certain example implementations, methods and/or apparatuses may be provided for use in a mobile device having a display through which a presentation may be rendered for a user. By way of initial example, a mobile device may comprise a cell phone, a smart phone, a computer, a tablet, a navigation aid, a gaming device, music and/or video player device, a camera, etc.

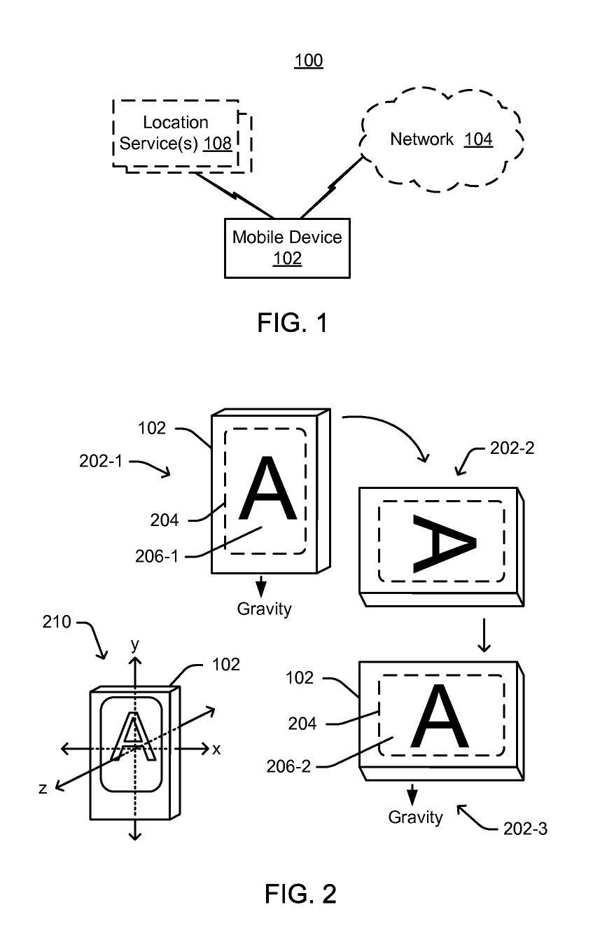

FIG. 1, for example, illustrates an environment 100 in which a mobile device 102 may be provided and moved about. Mobile device 102 is representative of any such electronic device having at least one display through which a presentation may be rendered for a user in a display mode selected from a plurality of predefined display modes. As used herein, a presentation is representative of any content or other like data that may be processed in some manner to render one or more visible objects and/or images on a display. By way of example but not limitation, a presentation may comprise video images, still images, graphics, text, a graphical user interface, touch screen controls, etc.

In certain example implementations, mobile device 102 may function exclusively and/or selectively as a stand-alone device, and/or may provide a one or more capabilities/services of interest/use to a user. In certain example implementations, mobile device 102 may communicate in some manner with one or more other devices, for example, as illustrated by the wireless communication link to the cloud labeled network 104. Network 104 is representative of one or more communication and/or computing resources (e.g., devices and/or services) which mobile device 102 may communicate with or through using one or more wired or wireless communication links. Thus, in certain instances mobile device 102 may receive data and/or instructions via network 104. In certain example implementations, information associated with all or part of a presentation may be obtained via network 104.

In certain example implementations, mobile device 102 may be enabled to use signals received from one or more location services 108. Location service(s) 108 is representative of one or more wireless signal based location services such as, a Global Navigation Satellite System (GNSS), or other like satellite and/or terrestrial locating service, a location based service (e.g., via a cellular network, a WiFi network, etc.).

Device 102 may, for example, be enabled (e.g., via one or more network interfaces) for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like.

Given that such mobile devices may be moved about and oriented in various ways by a user, it is known to provide different display modes for use by (during) a presentation. Some example display modes include portrait and landscape modes which may relate, for example, to a proportional ratio of either the presentation's content and/or the display itself. Certain example mobile devices are enabled to identify an orientation of the display of the display device and to select (typically automatically) a display mode.

For example, in FIG. 2 some graphically illustrated examples of mobile device 102 are shown at various moments in time as having certain orientations. Here, for example, mobile device 102 comprises a display 204 through which a presentation (represented by the capital letter “A”) may be rendered.

At time 202-1, an orientation may be determined based, at least in part, on gravitational attraction represented here by an arrow (e.g., a vector). By way of example, one or more inertial sensors within mobile device 102 may detect and/or measure motion and/or other phenomenon (e.g., magnetism, etc.) that is experienced and based on which an orientation may be determined. For this example, at time 202-1 a display mode 206-1 is selected. Here, for example, display mode 206-1 may comprise a portrait mode.

As indicated by the curved arrow, should mobile device be subsequently moved to a different orientation at time 202-2 then such a portrait mode may not be as useful. Hence, at a later time 202-3, having identified that the motion and/or that the affects of the gravitational attraction are now different, a different display mode 206-2 is selected. Here, for example, display mode 206-2 may comprise a landscape mode.

As further illustrated in FIG. 2, an orientation 210 associated with mobile device 102 may, for example, be represented by a coordinate system such as that shown by axis labeled x, y, and z, with an origin that may be placed at a reference point associated with the mobile device and/or display. Such reference point may, for example, be centered or offset in some manner.

It should be noted that while the examples illustrated herein show a rectangular shaped display, claimed subject matter is not so limited, the a display may take other shapes. For example, in accordance with certain example implementations herein, a display may have an oval or round shape, or the like. Here, for example, instead of selecting one out of two modes, such as, e.g., a portrait or a landscape mode, such a mobile device may provide for a continuous rotation of the graphics (including virtual keyboard) or a plurality of selected discreet rotation angles (e.g., every 15 degrees). Thus, for example, as such a mobile device is held in a vertical plane, an orientation of the presentation of graphics with respect to the user and motion may be kept horizontal, perhaps even using various known image stabilization techniques. Hence, with the techniques provided herein, when such a mobile device is held close to a horizontal plane the presented graphics, etc., in the display may be substantially aligned for the user based, at least in part, on a sensed direction of movement.

It may also be beneficial to identify (e.g., via analysis and modeling) one or more particular “motion modes” which may be considered when selecting between different display modes. For example an identified motion mode may classify that a user of a mobile station is walking or running, riding on a train or bus, or otherwise moving or being transported in some identifiable manner. As such, an identified motion mode may trigger a particular display mode and/or may be otherwise considered, possibly along with information about a motion direction.

Further, while all of the display is affected by display mode in the illustrated examples, in other implementations one or more portions of a display and/or presentation may not be affected in the same manner. For example, a display may apply different display modes for different presentations that are concurrently shown.

In the examples illustrated herein it is assumed that a preferred rendering of the presentation “A” via the display will likely place the capital letter “A” in a readable position to a user viewing the presentation. In the example orientations of FIG. 2, an assumption is made that a user will likely be standing or sitting and hence the capital letter “A” may be preferred to be vertically aligned closer to a force vector representative of Earth's gravitational attraction. In other words, the display mode may be selected to have the capital letter “A” standing “upright” for user viewing with the assumption being that the user is also “upright”.

While such assumptions and techniques usually work well, there may be certain orientations wherein the assumption regarding a user's relative viewing position becomes unreliable or undetermined. For example, if a mobile device is held horizontally level (e.g., as if set on a level table top) and/or shaped such that the surface of the display is held horizontally level, then it may be difficult to determine a likely angle from which a user may be viewing a presentation and if a display mode selection may be correct or if a change may be useful. Such issues may arise regardless as to whether a user is stationary or moving.

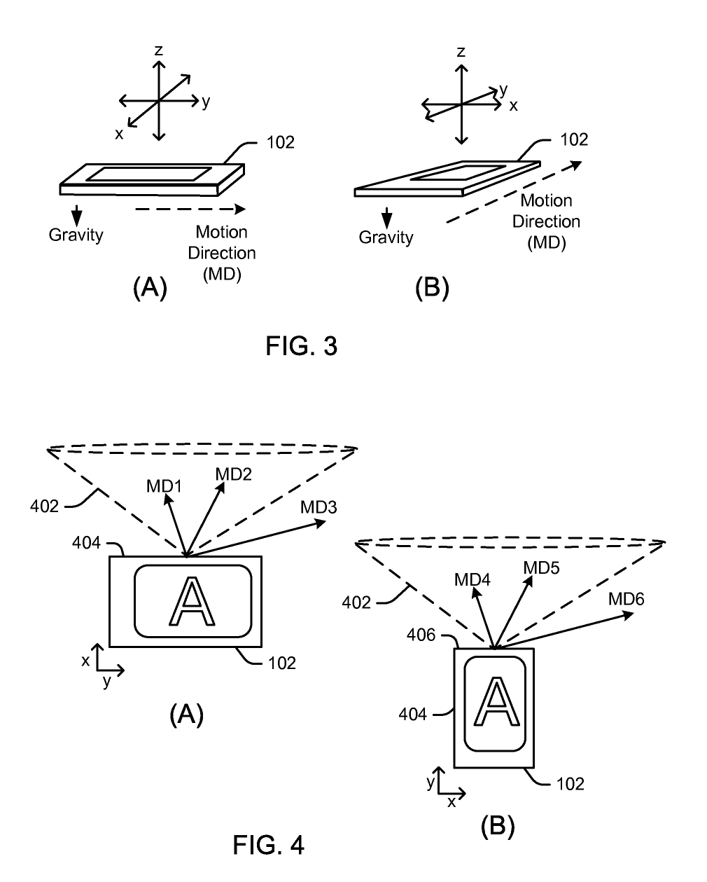

For example, see FIG. 3A-B, wherein a mobile device 102 is illustrated in orientations that place a viewing surface of the display in a substantially level or horizontal position with regard to the gravitational attraction.

Here, for example, the viewing surface of the display may be aligned on a representative plane (here, e.g., the x-y plane). Further, a force vector representative of Earth's gravitational attraction may extend in some manner along the z-axis. Obviously, the previous example assumptions that worked well for a more tilted display to infer the user's likely position may not work as well since the display is either level or perhaps only slightly tilted.

In accordance with an aspect of this description, methods and apparatuses may be implemented to determine that an orientation of a display of a mobile device is within one or more threshold angular ranges (e.g., relating to a tilt of a viewed surface, etc., of the display). Here, for example, a threshold angular range may relate to an orientation wherein a display is at or near a “level” or “horizontal” presentation. By way of example, but not limitation, an orientation of a display may be determined to be at or near a “level” or “horizontal” presentation when a display (e.g., a viewed surface) is within a threshold angular range of a representative plane that is substantially perpendicular to a force vector representative of Earth's gravitational attraction. The methods and apparatuses may identify motion direction (MD) of the mobile device, e.g., with respect to the orientation of the display. A motion direction may, for example, relate to a particular relative direction, a velocity, etc. Here, for example, as described in greater detail below such motion direction may represent movement during a period of time along one or more angles within the threshold angular range. Hence, it may be useful to assume that a user who is moving with the mobile device may be facing in or about the same direction as the motion direction. Thus, based, at least in part, on the motion direction, a display mode may be selected from a plurality of predefined display modes for use by a presentation.

As mentioned, in certain example implementations an assumption may be made that a user who is moving with a mobile device may be facing in or about the same direction as a direction of the motion. In other example implementations, it may be that the user is facing a different direction from a direction of the motion. For example, a user may be seated on a moving vehicle but facing sideways or backwards with respect to a direction of the motion. Thus, in certain example implementations, user input and/or other automated techniques may be employed to select a display mode for the occasion, e.g., based on an identified motion mode.

By way of non-limiting example, a mobile device orientation relative to a motion direction may be obtained (or a motion mode identified) using one or more motion sensors (e.g., an accelerometer, a gyroscope, etc.) and/or one or more directional sensors (e.g., a compass, a magnetometer, etc.) to determine an absolute direction and/or orientation (e.g., with regard to North and South magnetic poles). Combining such techniques/information may, for example, allow for a user's motion mode to be identified (e.g., determined or estimated) even though the mobile device's direction motion may comprise an additional motion in some direction, e.g., as may be the case when a user in moving about a ship which itself is moving.

In FIG. 4A-B, a surface of a display of a mobile device 102 is assumed to be within a threshold angular range of a representative plane that is substantially perpendicular to a force vector representative of Earth's gravitational attraction (e.g., which would extend through the page along with the z-axis). Here, the x-axis and y-axis are shown.

In FIG. 4A, for example, given the shape of the example mobile device 102 and display a reference point placed on a surface 404. During a first period of time, a motion direction MD1 may be identified to be along one or more angles within a threshold angular range 402, for example. Accordingly, as illustrated, a display mode may be selected that places the presentation “A” in “readable” position wherein it is assumed that the user may be viewing it from. In other words, in this example, it may be assumed that the user may be facing in the direction of MD1. During a second period of time, a motion direction MD2 may, for example, be identified to be along one or more angles within threshold angular range 402. Accordingly, the current display mode may be maintained. However, during a third period of time, a motion direction MD3 may, for example, be identified to be along one or more angles that are not within threshold angular range 402. Accordingly, the current display mode may not be as useful. Thus, a different display mode may be selected. As previously mentioned, in certain instances, an identified motion mode may also, or alternatively, be considered when determining a display mode.

FIG. 4B is similar to FIG. 4A, with an example reference point placed on a surface 406. In other implementations, the reference point may still be placed on surface 406. Here, during a forth period of time, a motion direction MD4 may be identified to be along one or more angles within a threshold angular range 402, for example. Accordingly, as illustrated, a display mode may be selected that places the presentation “A” in (different) “readable” position wherein it is assumed that the user may be viewing it from. In other words, in this example, it may be assumed that the user may be facing in the direction of MD4. During a fifth period of time, a motion direction MD5 may, for example, be identified to be along one or more angles within threshold angular range 402. Accordingly, the current display mode may be maintained. However, during a sixth period of time, a motion direction MD6 may, for example, be identified to be along one or more angles that are not within threshold angular range 402. Accordingly, the current display mode may not be as useful.

Note that, while not shown, a threshold angular range 402 may extend fully around all of mobile device 102 or may just cover a portion of a region relating to mobile device 102. Hence, in certain examples, a threshold angular range 402 may identify one or more contiguous regions of space in relationship to mobile device 102. For example, in certain implementations a threshold angular range 402 may take into account certain design, functional, and/or operative aspects of a mobile device to establish a particular threshold angular range. For example, in certain implementations a threshold angular range 402 may take into account certain measured or otherwise identified parameters that may conditionally or otherwise affect a threshold angular range. For example, velocity information (if available) may be used to infer a mode of transportation or possibly identify a motion mode associated with the mobile device. Here, for example, if a measured or otherwise obtained or estimated velocity is greater than an example threshold value, then it may be assumed that the user and mobile device are traveling in a vehicle, on a train, or perhaps onboard a jet airliner, rather than walking. Hence, parameters relating to motion, barometric pressure, compass measurements, and/or other like information may affect a threshold angular range. As such, a threshold angular range may be affected in some manner and/or other conditional decisions made with regard to selection of a display mode and/or use of a motion direction.

The example threshold angular range illustrated in FIG. 4 may be applied for both motion direction and orientation determination. In other example implementations, motion direction and orientation determination may use different threshold angular ranges. Indeed, it may be useful to select, set or otherwise affect all or part of one or more such threshold angular ranges at times, such as, e.g., based on an identified motion mode, etc.

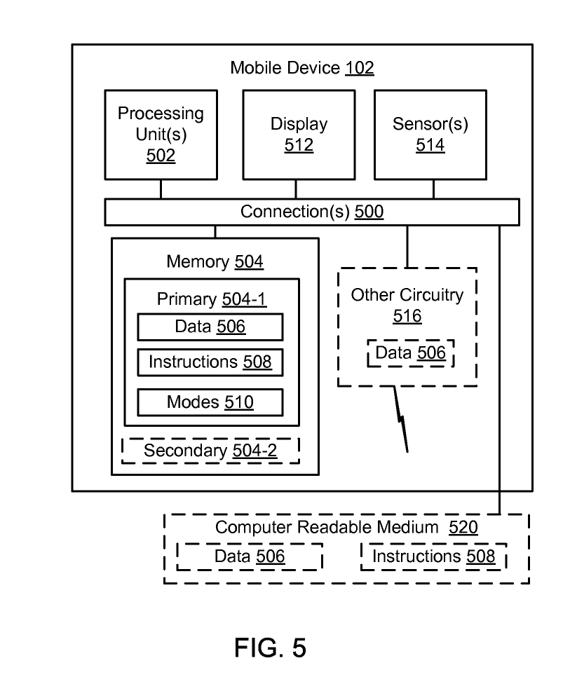

Reference is made next to FIG. 5, which is a schematic block diagram illustrating certain features of mobile device 102, for example as in FIG. 1, in accordance with an implementation.

As illustrated mobile device 102 may comprise one or more processing units 502 to perform data processing (e.g., in accordance with the techniques provided herein) coupled to memory 504 via one or more connections 500. Processing unit(s) 502 may be implemented in hardware or a combination of hardware and software. Processing unit(s) 502 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, and the like, or any combination thereof.

Memory 504 may be representative of any data storage mechanism. Memory 504 may include, for example, a primary memory 504-1 and/or a secondary memory 504-2. Primary memory 504-1 may comprise, for example, a random access memory, read only memory, etc. While illustrated in this example as being separate from the processing units, it should be understood that all or part of a primary memory may be provided within or otherwise co-located/coupled with processing unit(s) 502, or other like circuitry within mobile device 102. Secondary memory 504-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, computer readable medium 520. As illustrated, memory 504 and/or computer readable medium 520 may comprise data 506, instructions 508, and/or one or more display modes 510, associated with data processing (e.g., in accordance with the techniques provided herein).

Mobile device 102 may, for example, further comprise one or more displays 512, which may be coupled to one or more of connections 500. By way of example, a display 512 may comprise a liquid crystal display, touch screen display, and/or the like, which may be used in rendering a presentation viewable by a user.

Mobile device 102 may, for example, further comprise one or more sensors 514, which may be coupled to one or more of connections 500. By way of example, sensors 514 may comprise one or more inertial sensors (e.g., an accelerometer, a gyroscope, etc.), a barometer, a compass, a magnetometer, and/or the like, which may be used in identifying a motion direction, determining an orientation, identifying a motion mode, and/or otherwise provide information that may be considered in selecting a display mode, identifying one or more thresholds, setting periods of time, etc.

Mobile device 102 may, for example, further comprise other circuitry 516, etc., which may or may not be coupled to one or more of connections 500. Here, for example, other circuitry 516 may vary widely in its scope depending on other functionality and/or capabilities of mobile device 102. For example, other circuitry 516 may comprise a power supply, a device to access a computer readable medium, etc. For example, other circuitry 516 may comprise one or more user interfaces, such as, a microphone, a camera, one or more buttons/etc., and/or one or more tactile interfaces (e.g., a vibrating mechanism, etc.). Other user interfaces may comprise a biometric reader or other like authentication interface, a speaker or buzzer or other like audible interface, and/or various visual interfaces such as LEDs, lights, etc.

Other circuitry 516 may comprise one or more location service receivers and/or network interfaces, which may be coupled to one or more of connections 200. For example, a location service receiver and/or a network interface may be used in identifying a motion direction, determining an orientation, identifying a motion mode, and/or otherwise provide information that may be considered in selecting a display mode, identifying one or more thresholds, setting periods of time, etc. A network interface may be used to obtain data 506 and or instructions 508. Here, for example, data 506 may comprise information associated with a presentation.

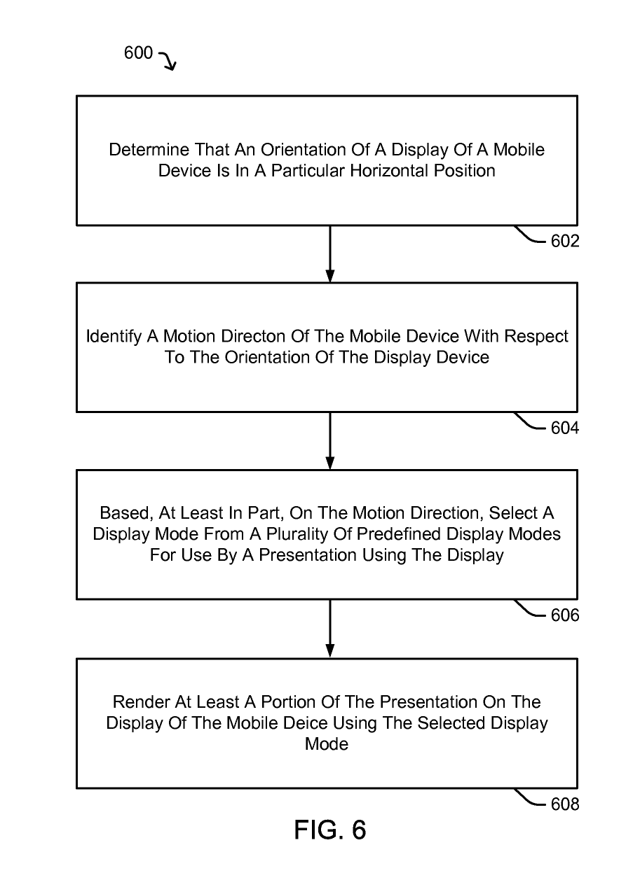

Attention is drawn next to FIG. 6, which is flow diagram illustrating an example process 600 for use in a mobile device to select one or more display modes based, at least in part, on a motion direction, in accordance with an implementation.

At block 602, an orientation of a display of a mobile device may be determined to be in a particular horizontal position. For example, a display of a mobile device may be determined to be in a particular horizontal position when the display is deemed to be within a threshold angular range. Such threshold angular range may, for example, be relative to a representative plane that is substantially perpendicular to a force vector representative of Earth's gravitational attraction.

At block 604, a motion direction of the mobile device may be identified with respect to an orientation of a display. Here, for example, the motion direction may represent movement of the mobile device (e.g., during a period of time) along one or more angles within a threshold angular range. Such a threshold angular range may, for example, be relative to a representative plane that is substantially perpendicular to a force vector representative of Earth's gravitational attraction.

At block 606, based, at least in part, on the motion direction, a display mode may be selected from a plurality of predefined display modes for use by a presentation using the display. For example, a different display mode from the plurality of predefined display modes may be selected in response to a determination that the orientation of the mobile device and/or a current display mode are incompatible with the motion direction. Conversely, for example, a current display mode may be maintained in response to a determination that the orientation of the mobile device and/or a current display mode are compatible with the motion direction. If, for example, a display mode has not been previously selected and/or no default exists, then a display may be selected which may be useful in light of the motion direction.

In certain example implementations, process 600 may further comprise identifying that motion-based display mode selection is permitted, prior to selecting the display mode, and/or identifying that the motion direction satisfies an applicable threshold level (e.g., velocity threshold, etc.), and or considering an identified motion mode prior to selecting the display mode

At block 608, at least a portion of a presentation may be rendered for a user to view on the display of the mobile device using the selected display mode.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, with a mobile device:
in response to determining that an orientation of a display of said mobile device is in a particular horizontal position, identifying a motion direction of said mobile device with respect to said orientation of said display; and
selecting a display mode from a plurality of predefined display modes for use by a presentation using said display based, at least in part, on said motion direction.

2. The method as recited in claim 1, further comprising:
determining that said orientation of said display is in said particular horizontal position based, at least in part, on a threshold angular range.

3. The method as recited in claim 1, wherein said motion direction represents movement during a period of time of said mobile device along one or more angles within a threshold angular range.

4. The method as recited in claim 1, further comprising:
selecting said display mode based, at least in part, on an identified motion mode.

5. The method as recited in claim 2, wherein determining that said orientation of said display is within said threshold angular range comprises:
determining that said orientation is within said threshold angular range of a representative plane that is substantially perpendicular to a force vector representative of Earth's gravitational attraction.

6. The method as recited in claim 1, wherein selecting said display mode further comprises:
maintaining a current display mode in response to a determination that said orientation of said mobile device and/or a current display mode are compatible with said motion direction.

7. The method as recited in claim 1, wherein selecting said display mode further comprises:
selecting a different display mode from said plurality of predefined display modes in response to a determination that said orientation of said mobile device and/or a current display mode are incompatible with said motion direction.

8. The method as recited in claim 1, further comprising:
identifying that motion-based display mode selection is permitted, prior to selecting said display mode.

9. The method as recited in claim 1, further comprising:
identifying that said motion direction satisfies a velocity threshold level, prior to selecting said display mode.

10. The method as recited in claim 1, wherein said orientation of said display of said mobile device and said motion direction are associated with a common reference point.

11. The method as recited in claim 1, wherein at least two of said plurality of predefined display modes are associated with different presentation formats.

12. The method as recited in claim 11, wherein said different presentation formats comprise different aspect ratios.

13. The method as recited in claim 11, wherein said different presentation formats comprises at least a portrait format and a landscape format.

14. The method as recited in claim 1, further comprising:
rendering said presentation on said display of said mobile device using said selected display mode.

15. An apparatus comprising:
means for identifying a motion direction of a mobile device with respect to an orientation of a display, in response to determining that said orientation of said display of said mobile device is in a particular horizontal position; and means for selecting a display mode from a plurality of predefined display modes for use by a presentation using said display based, at least in part, on said motion direction.

16. The apparatus as recited in claim 15, further comprising:
means for determining that said orientation of said display is in said particular horizontal position based, at least in part, on a threshold angular range.

17. The apparatus as recited in claim 15, wherein said motion direction represents movement during a period of time of said mobile device along one or more angles within a threshold angular range.

18. The apparatus as recited in claim 15, further comprising:
selecting said display mode based, at least in part, on an identified motion mode.

19. The apparatus as recited in claim 16, further comprising:
means for determining that said orientation is within said threshold angular range of a representative plane that is substantially perpendicular to a force vector representative of Earth's gravitational attraction.

20. The apparatus as recited in claim 15, further comprising:
means for maintaining a current display mode in response to a determination that said orientation of said mobile device and/or a current display mode are compatible with said motion direction.

21. The apparatus as recited in claim 15, further comprising:
means for selecting a different display mode from said plurality of predefined display modes in response to a determination that said orientation of said mobile device and/or a current display mode are incompatible with said motion direction.

22. The apparatus as recited in claim 15, further comprising:
means for identifying that motion-based display mode selection is permitted, prior to selecting said display mode.

23. The apparatus as recited in claim 15, further comprising:
means for identifying that said motion direction satisfies a velocity threshold level, prior to selecting said display mode.

24. The apparatus as recited in claim 15, wherein said orientation of said display of said mobile device and said motion direction are associated with a common reference point.

25. The apparatus as recited in claim 15, wherein at least two of said plurality of predefined display modes are associated with different presentation formats.

26. The apparatus as recited in claim 25, wherein said different presentation formats comprise different aspect ratios.

27. The apparatus as recited in claim 25, wherein said different presentation formats comprises at least a portrait format and a landscape format.

28. The apparatus as recited in claim 15, further comprising:
means for rendering said presentation on said display of said mobile device using said selected display mode.

29. An apparatus comprising:
at least one motion sensor; and
at least one processing unit to:
determine that an orientation of a display of a mobile device is in a particular horizontal position;
determine a motion direction of said mobile device with respect to said orientation of said display, in response to a determination that said orientation of said display is in said particular horizontal position; and
selecting a display mode from a plurality of predefined display modes for use by a presentation using said display based, at least in part, on said motion direction.

30. The apparatus as recited in claim 29, said at least one processing unit to further:
determine that said orientation of said display is in said particular horizontal position based, at least in part, on a threshold angular range.

31. The apparatus as recited in claim 29, wherein said motion direction represents movement during a period of time of said mobile device along one or more angles within a threshold angular range.

32. The apparatus as recited in claim 29, said at least one processing unit to further:
select said display mode based, at least in part, on an identified motion mode.

33. The apparatus as recited in claim 30, said at least one processing unit to further determine that said orientation is within said threshold angular range of a representative plane that is substantially perpendicular to a force vector representative of Earth's gravitational attraction.

34. The apparatus as recited in claim 29, said at least one processing unit to further maintain a current display mode in response to a determination that said orientation of said mobile device and/or a current display mode are compatible with said motion direction.

35. The apparatus as recited in claim 29, said at least one processing unit to further select a different display mode from said plurality of predefined display modes in response to a determination that said orientation of said mobile device and/or a current display mode are incompatible with said motion direction.

36. The apparatus as recited in claim 29, said at least one processing unit to further identify that motion-based display mode selection is permitted, prior to selecting said display mode.

37. The apparatus as recited in claim 29, said at least one processing unit to further identify that said motion direction satisfies a velocity threshold level, prior to selecting said display mode.

38. The apparatus as recited in claim 29, wherein said orientation of said display of said mobile device and said motion direction are associated with a common reference point.

39. The apparatus as recited in claim 29, wherein at least two of said plurality of predefined display modes are associated with different presentation formats.

40. The apparatus as recited in claim 39, wherein said different presentation formats comprise different aspect ratios.

41. The apparatus as recited in claim 39, wherein said different presentation formats comprises at least a portrait format and a landscape format.

42. The apparatus as recited in claim 29, said at least one processing unit to further initiate rendering of said presentation on said display of said mobile device using said selected display mode.

43. An article comprising:
a computer readable medium comprising computer implementable instructions stored therein that are executable by one or more processing units to:
determine that an orientation of a display of a mobile device is in a particular horizontal position;
determine a motion direction of said mobile device with respect to said orientation of said display, in response to a determination that said orientation of said display is in said particular horizontal position; and
selecting a display mode from a plurality of predefined display modes for use by a presentation using said display based, at least in part, on said motion direction.

44. The article as recited in claim 43, wherein said computer implementable instructions are further executable to:
determine that said orientation of said display is in said particular horizontal position based, at least in part, on a threshold angular range.

45. The article as recited in claim 43, wherein said motion direction represents movement during a period of time of said mobile device along one or more angles within a threshold angular range.

46. The article as recited in claim 43, wherein said computer implementable instructions are further executable to:
select said display mode based, at least in part, on an identified motion mode.

47. The article as recited in claim 44, wherein said computer implementable instructions are further executable to:
determine that said orientation is within said threshold angular range of a representative plane that is substantially perpendicular to a force vector representative of Earth's gravitational attraction.

48. The article as recited in claim 43, wherein said computer implementable instructions are further executable to:
maintain a current display mode in response to a determination that said orientation of said mobile device and/or a current display mode are compatible with said motion direction.

49. The article as recited in claim 43, wherein said comprising computer implementable instructions are further executable to:
select a different display mode from said plurality of predefined display modes in response to a determination that said orientation of said mobile device and/or a current display mode are incompatible with said motion direction.

50. The article as recited in claim 43, wherein said comprising computer implementable instructions are further executable to:
identify that motion-based display mode selection is permitted, prior to selecting said display mode.

51. The article as recited in claim 43, wherein said comprising computer implementable instructions are further executable to:
identify that said motion direction satisfies a velocity threshold level, prior to selecting said display mode.

52. The article as recited in claim 43, wherein said orientation of said display of said mobile device and said motion direction are associated with a common reference point.

53. The article as recited in claim 43, wherein at least two of said plurality of predefined display modes are associated with different presentation formats.

54. The article as recited in claim 53, wherein said different presentation formats comprise different aspect ratios.

55. The article as recited in claim 53, wherein said different presentation formats comprises at least a portrait format and a landscape format.

56. The article as recited in claim 43, wherein said comprising computer implementable instructions are further executable to:
initiate rendering of said presentation on said display of said mobile device using said selected display mode.
